(19) United States
(12) Patent Application Publication
(10) Pub. No.: US 2006/0091636 A1
(43) Pub. Date: May 4, 2006

(54) Dual diagonal stabilizer bars for vehicles

(76) Inventor: David T. Shelton, Waxahachie, TX (US)

Correspondence Address: W. THOMAS TIMMONS;THE WHITE HOUSE ON TURTLE CREEK, 2401 TURTLE CREEK BLVD, DALLAS, TX, 75219-4760, US

(21) Appl. No.: 11/253,459

(22) Filed: Oct. 19, 2005

Related U.S. Application Data
(60) Provisional application No. 60/623,262, filed on Oct. 29, 2004.

(51) Int. Cl. B60G 21/055; B60G 11/18

(52) U.S. Cl. 280/124.107; 280/124.165; 280/124.167

(57) ABSTRACT

Dual, diagonal bars to reduce vehicle roll and pitch rates, thereby stabilizing the vehicle, are disclosed. One bar attaches linking the left front suspension to the right rear suspension, and the other bar links the right front suspension and the left rear suspension. Attachment points link alternate corners rather than being on the same axle. The bars are attached to the suspension with additional attachment to either the suspension or the chassis. The primary means of mounting, or attaching, the bars is in at least four spots for each bar. There may be a need to add one additional mount, or more, per bar along the long section of the bar between the front and rear chassis mounts to control flex and provide a more pleasant ride. The opposing end of the bar is attached to the rear suspension outboard near the spring mount on a live rear axle, or on the control arm of an independent rear suspension. A sleeve could replace the two mounts that are on the suspension. An alternate method of mounting the bars is to have the bars effectively mounted in two places along each suspension arm, thereby causing the bar to act as a torsion bar.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to suspension and stabilization of vehicles, and in one of its aspects, to stabilizer bars.

2. Description of Related Art

There have been many attempts to stabilize automobiles and other vehicles, preventing rollovers such as those shown in U.S. Pat. No. 3,992,026 by Allison, in U.S. Pat. No. 4,915,409 by Shuit and in U.S. Pat. No. 6,173,978 by Wagner. Allison and Shuit show stabilizing systems which are basically in a four sided configuration. Wagner changes the suspension system.

### BRIEF SUMMARY OF THE INVENTION

The dual, diagonal bars of the present invention reduce the vehicle roll and pitch rates, thereby stabilizing the vehicle. The bars mount as follows: one attaches linking the left front suspension to the right rear suspension; the other bar links the right front suspension and the left rear suspension. Attachment points are similar to anti-roll bars, yet are different in that they link alternate corners rather than being on the same axle. By doing this the invention controls both roll and pitch as opposed to only controlling roll.

Since traction is lost at a greater rate by the decrease of weight, or down-force, on one portion of the vehicle faster than traction can be gained by the addition of weight, or down-force, on another portion of the vehicle, slowing down the transfer rate will preserve traction and, therefore, control. This should provide more stability, and better cornering ability. It also should allow for, by altering front and rear tensions, the ability to control over-steer and under-steer. An additional benefit is gained when towing a trailer by maintaining a more level platform, thereby providing more stability when towing.

There are several means, or methods, for attaching the bars to the suspension and the chassis. This device provides a benefit for many, if not all, suspension types. The primary means of mounting, or attaching, the bars is in at least four spots for each bar. One end of the bar is to be mounted outboard usually on the lower front control arm. After a bend in the bar, there is a mount to locate the bar on the chassis where it can pivot freely. There will need to be another chassis mount near the rear of the vehicle just before the bar is bent to angle back to the rear suspension mount. There may be a need to add one additional mount, or more, per bar along the long section of the bar between the front and rear chassis mounts to control flex and provide a more pleasant ride. The opposing end of the bar is attached to the rear suspension outboard near the spring mount on a live rear axle, or on the lower control arm of an independent rear suspension. A sleeve could replace the two mounts that are on the suspension, which may eliminate the need for chassis mounts.

An alternate method of mounting the bars is to have the bars effectively mounted in two places along each suspension arm, thereby causing the bar to act as a torsion bar. These diagonal cross bars provide some of their benefit by restricting some of the independence of the suspensions, and causing a more diagonal interdependence between suspensions at opposing corners of the vehicle. Preload adjusters and adjustable mounting positions along the bar ends may be used to allow fine tuning for maximum stability or vehicle performance.

The present invention is to be a vehicle stabilizer to control the roll rate or combined roll and pitch rate of any 4 or more wheeled (tired) vehicle utilizing a suspension, providing an increase in vehicle stability. All suspension types are included. Added benefit is to stabilize and control the vehicle when towing a trailer with the vehicle.

Attaching two diagonally opposed corners (wheel suspensions) together through the use of elastic (torsion and flex) bars or tubes, attached in usually four places also. These are usually attached on the lower control arm and/or axle housing and attached in at least two locations on the chassis (frame, or sub-frame). These can be either two independent bars or two bars which are made up of several pieces to create two bars.

In some situations, lightweight composites are preferred, such as tubes instead of bars or flexible plates instead of bars. Bars can also be made in sections with slip fit connections to ease in shipping of kits. Extra attachments along bars can be used to brace and reduce noise. Different lever arms can also be used as attachments to main elastic (torsion bar) bar to aid in precision, or shipping, and production cost savings.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a right front perspective of a combined frame, suspension and stabilizer bars according to the present invention;

FIG. 2 is a top view of the invention of FIG. 1;

FIG. 3 is a bottom perspective view of a suspension mount on a live rear axle suspension;

FIG. 4 is a perspective view of a suspension mount on an I-beam front suspension;

FIG. 5 is a perspective view of an alternative embodiment of a suspension mount system on a live rear axle; and

FIG. 6 is an elevation view of an alternative embodiment of a suspension mount system on an unequal length A-arm front suspension.

### DETAILED DESCRIPTION OF THE INVENTION

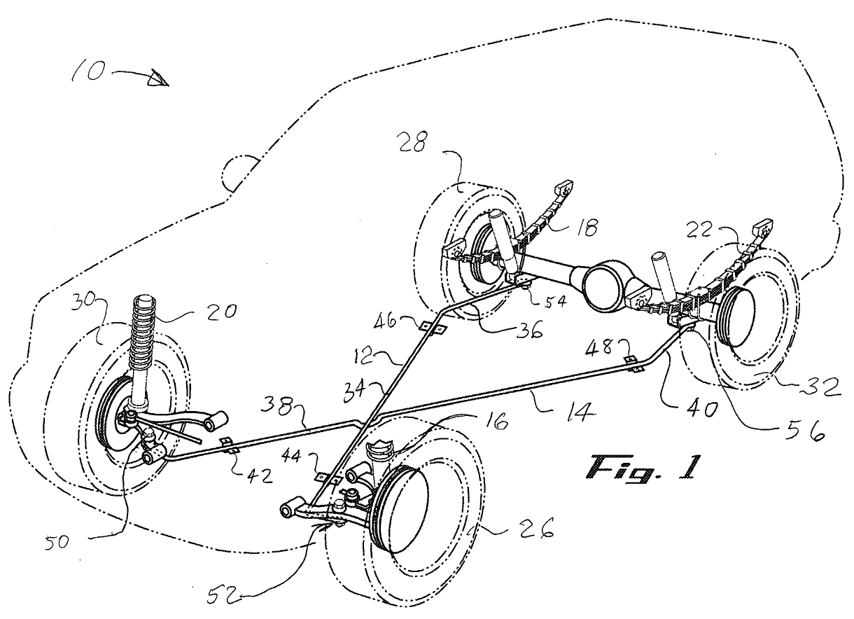

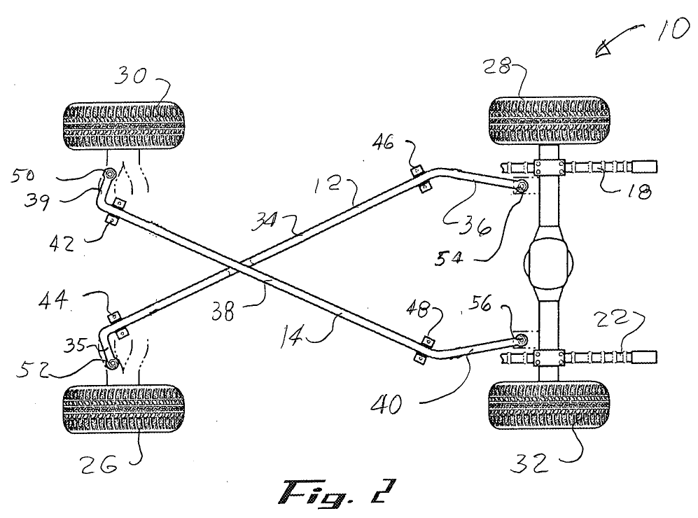

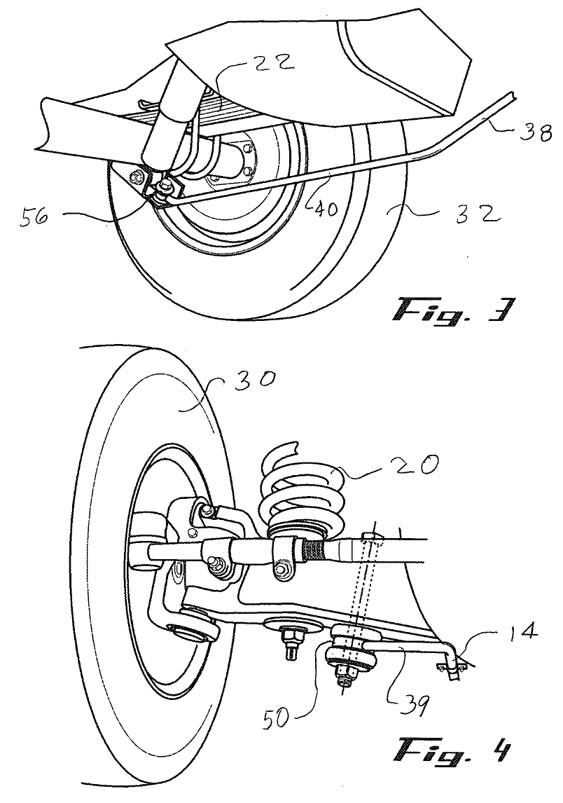

Referring now to the drawing, and in particular to FIG. 1 and FIG. 2, a combined automotive frame, suspension and stabilizer bars according to the present invention is referred to generally by reference numeral 10. The dual, diagonal bars 12 and 14 of the present invention reduce the vehicle roll and pitch rates, thereby stabilizing the vehicle. The bars mount as follows: one bar 12 attaches linking the left front suspension 16 associated with left front wheel 26 to the right rear suspension 18 associated with right rear wheel 28; the other bar 14 links the right front suspension 20 associated with right front wheel 30 to the left rear suspension 22 associated with left rear wheel 32, where directions are taken with respect to a driver of the vehicle. Diagonal bar 12 forms a torsion section 34, a front lever arm 35 and a rear lever arm 36. Similarly, diagonal bar 14 forms a torsion section 38, a front lever arm 39 and a rear lever arm 40. Attachment points are similar to anti-roll bars, yet are different in that they link alternate corners rather than being on the same axle. Front chassis mounts 42 and 44 mount the front end of torsion sections 38 and 34 respectively to the chassis, allowing for rotation or torsion of the bars 12 and 14. Similarly, rear chassis mounts 46 and 48 mount the rear end of torsion sections 34 and 38 respectively to the chassis, allowing for rotation or torsion of the bars 12 and 14. Referring also to FIG. 3 and FIG. 4, front end links 50 and 52 attach stabilizer bars 14 and 12 to front suspensions 20 and 16 respectively. Rear end links 54 and 56, similarly, attach stabilizer bars 12 and 14 to rear suspensions 18 and 22 respectively. By doing this the invention controls both roll and pitch as opposed to only controlling roll. These are illustrated with an unequal arm-length or wishbone front suspension with a MacPherson Strut and a live rear axle leaf-spring suspension, but would work in a similar fashion for other types of suspension.

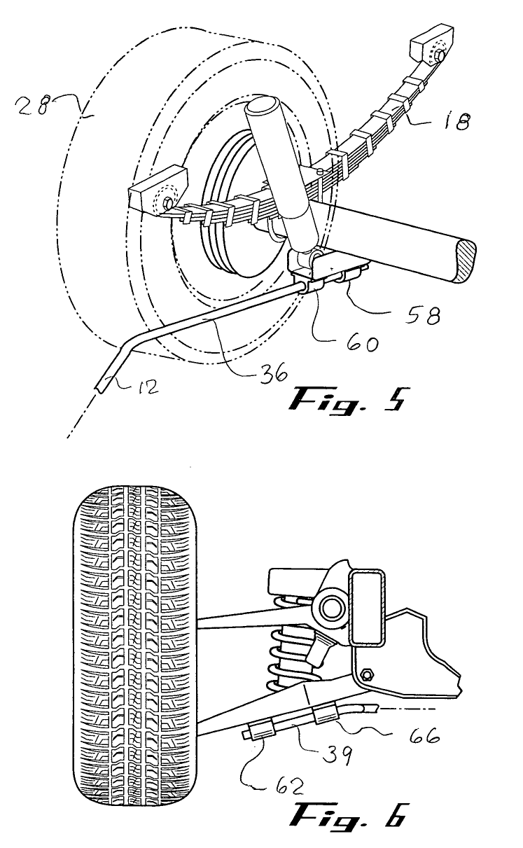

Referring now to FIG. 5 and FIG. 6, an alternative rear link 58 works in conjunction with a locator mount 60, and an alternative front end link 62 attaches to a front lever arm and works in conjunction with a locator mount 66. Locator mounts can substitute for chassis mounts under the right circumstances.

Since traction is lost at a greater rate by the decrease of weight, or down-force, on one portion of the vehicle faster than traction can be gained by the addition of weight, or down-force, on another portion of the vehicle, slowing down the transfer will preserve traction and, therefore, control. This should provide more stability, and better cornering ability. It also should allow for, by altering front and rear tensions, the ability to control over-steer and under-steer. An additional benefit is gained when towing a trailer by maintaining a more level platform, thereby providing more stability when towing.

There are several means, or methods, for attaching the bars to the suspension and the chassis. This device provides a benefit for many, if not all, suspension types. The primary means of mounting, or attaching, the bars is in at least four spots for each bar such as chassis mounts 42 and 48 and end mounts 50 and 56 for bar 14 and chassis mounts 44 and 46 and end mounts 52 and 54 for bar 12. One end of the bar is to be mounted outboard usually on the lower front control arm of the suspension. After a bend in the bar, there is a mount to locate the bar on the chassis where it can pivot freely. There will need to be another chassis mount near the rear of the vehicle just before the bar is bent to angle back to the rear suspension mount. There may be a need to add one additional mount, or more, per bar along the long section of the bar between the front and rear chassis mounts to control flex and provide a more pleasant ride. The opposing end of the bar is attached to the rear suspension outboard near the spring mount on a live rear axle, or on the lower control arm of an independent rear suspension.

An alternate method of mounting the bars is to have the bars effectively mounted in two places along each suspension arm such as rear link 58 with locator mount 60, and front end link 62 with locator mount 66, thereby causing the bar to act as a torsion bar. These diagonal cross bars provide some of their benefit by restricting some of the independence of the suspensions, and causing a more diagonal interdependence between suspensions at opposing corners of the vehicle.

The present invention is to be a vehicle stabilizer to control the roll rate of any 4 or more wheeled (tired) vehicle, utilizing a suspension, providing an increase in vehicle stability. All suspension types are included. Added benefit is to stabilize and control the vehicle when towing a trailer with the vehicle.

Attaching two diagonally opposed corners (wheel suspensions) together through the use of elastic (torsion and flex) bars or tubes, attached in usually four places also. These are usually attached on the lower control arm and/or axle housing and attached in two locations on the chassis (frame, or sub-frame). These can be either two independent bars or two bars which are made up of several pieces to create two bars.

In some situations, lightweight composites are preferred, such as tubes instead of bars or flexible plates instead of bars. Bars can also be made in sections with slip fit connections to ease in shipping kits. Extra attachments along bars can be used to brace and reduce noise. Different lever arms can also be used as attachments to main elastic (torsion bar) bar to aid in precision or shipping, and production cost savings.

The means of attachment are well known, in attaching the bars ends, or near ends either permanently, or by adjustable points, to the suspension component, usually a lower control arm or beside the spring mount. The bar is also usually attached to the chassis, frame, or sub-frame in at least two places, due to the length of the bars in some applications a third or fourth mount per bar may be necessary to reduce undue flex. The chassis mounts are sleeve like mounts that will allow the bar to twist yet locate it so that the suspension components use the bar as an opposing lever to each other.

The distinctive difference is that this invention utilizes the effects of opposing corners (suspensions left front to right rear, and right front to left rear) of the vehicle to resist the transfer of motion (energy), thereby slowing down the combined effects of cornering over the roll and pitch axes of motion and to some degree slowing or controlling the yaw by preserving traction and control.

The present invention is especially well adapted for vehicles that have a higher center of gravity than the low slung sports cars, and those vehicles that could use more stability and/or more predictable control or traction. An additional benefit is to those vehicles with a trailer hitch, when towing. The offsetting, opposing tendencies of the suspensions, when linked, reduce the rear load from added tongue weight, thereby maintaining a more normal vehicle level and increasing the stability of the vehicle as a whole. The present invention would be one well suited for the OE and replacement markets for vehicles such as SUVs, light trucks, crossovers, many sedans, some sports cars, race cars, ATVs, motor homes, buses, trucks and radio controlled race cars.

The main bars and lever arms may form additional bends. These additional bends could be for a variety of reasons such as to allow adequate space and to be designed to not interfere with any additional components.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. An improved vehicle having a chassis, the improved vehicle, comprising in combination:
a left front suspension;
a right front suspension;
a left rear suspension;
a right rear suspension;
a first bar linking the left front suspension to the right rear suspension; and
a second bar linking the right front suspension to the left rear suspension.

2. An improved vehicle according to claim 1 wherein there is clearance between the first bar and the second bar whereby the two bars do not touch each other.

3. An improved vehicle according to claim 2 further comprising: a first front mount to locate the first bar on the chassis near the front of
the first bar wherein the first bar can pivot freely; a first rear mount to locate the first bar on the chassis near the rear of the
first bar wherein the first bar can pivot freely; a second front mount to locate the second bar on the chassis near the front
of the second bar wherein the second bar can pivot freely; and a second rear mount to locate the second bar on the chassis near the rear
of the second bar wherein the second bar can pivot freely.

4. An improved vehicle according to claim 3 wherein the first bar forms a torsion section, a front lever arm, and a rear lever arm and the second bar forms a torsion section, a front lever arm, and a rear lever arm.

5. An improved vehicle according to claim 2 wherein the first bar forms a torsion section, a rear lever arm and a front lever arm and the second bar forms a torsion section, a rear lever arm and a front lever arm, further including:
a front left locator mount attached to the front left suspension to locate the front lever arm of the first bar;
a front right locator mount attached to the front right suspension to locate the front lever arm of the second bar;
a rear left locator mount attached to the rear left suspension to locate the rear lever arm of the second bar; and
a rear right locator mount attached to the rear right suspension to locate the rear lever arm of the first bar.
